(19) United States
(12) Patent Application Publication
(10) Pub. No.: US 2016/0181780 A1
(43) Pub. Date: Jun. 23, 2016

(54) Systems and Methods for Subsea Cable Ground Fault Isolation

(71) Applicant: Hydril USA Distribution, LLC, Houston, TX (US)

(72) Inventors: William James Hatter, Houston, TX (US); Ronald Dean Brooks, Houston, TX (US)

(73) Assignee: Hydril USA Distribution, LLC, Houston, TX (US)

(21) Appl. No.: 14/972,266

(22) Filed: Dec. 17, 2015

Related U.S. Application Data
(60) Provisional application No. 62/092,973, filed on Dec. 17, 2014.

(51) Int. Cl. H02H 1/00; H02H 3/04; H02H 3/02; H02H 3/16

(52) U.S. Cl. CPC H02H 1/0061; H02H 3/16; H02H 3/04; H02H 3/021

(57) ABSTRACT

A ground fault isolation system and ground fault isolation circuit for isolating ground faults in electrical subsea conductor lines. The system includes a main power hub, a plurality of digital controllers operatively connected to the main power hub via electrical subsea conductor lines, and a ground fault isolation circuit. The ground fault isolation circuit includes a plurality of loads connected to a ground fault detection circuit, each load including one relay on the positive power bus and one relay on the negative power bus. The ground fault detection circuit is connected to a DC to DC isolation circuit that prevents a main power bus ground fault in the event of a ground fault on one of the loads. The relays are connected to a digital controller on the other end, which isolates a load when a ground fault is detected, but powers the remaining unaffected loads.

### CROSS-REFERENCE TO RELATED APPLICATIONS

This application claims the benefit of U.S. Provisional Application 62/092,973 filed on Dec. 17, 2014, the entire contents of which is incorporated herein by reference.

### TECHNICAL FIELD

This invention relates in general to control systems associated with subsea wells, and in particular to ground fault isolation circuits for isolating a ground fault in electrical subsea power lines.

### BACKGROUND

Subsea control systems associated with hydrocarbon production wells often include a diverse amount of subsea power distribution cables. Circuits that include such a diverse amount of power distribution cables can have significant granularity in debugging subsea ground faults. There are current devices available that have the ability to detect ground faults by adding a multiplex signal on top of the DC power, however this technique would interfere with transducer instrumentation and would also be physically large.

Generally a main power source, which may be floating on the ocean surface, is connected to multiple control pods, which may be located thousands of meters below the ocean surface. These connections may be made via electrical subsea power lines, such as, pressure balanced oil filled (PBOF) cables. Currently, there are systems that are able to detect ground faults in the main power bus of a subsea control system, and that are able to shut down the entire system or the entire blow out preventer (BOP) in case of a short circuit. However, existing systems are not able to isolate ground faults, or isolate a particular pod that may have experienced a ground fault.

Previously attempts have been made to identify ground faults in subsea systems. However, to identify a ground fault in existing systems power must be removed from the load and a relay module must be activated. This results in loss of power to the load, and thus does not offer continuous real-time fault monitoring of all loads connected to the main power source.

### SUMMARY

In one example embodiment, a ground fault isolation circuit has a DC to DC isolation converter for receiving an instrumentation power and isolating the instrumentation power from a main power bus, a ground fault detection circuit operatively connected to the DC to DC converter and configured to detect a ground fault in one or more loads operatively connected to the ground fault detection circuit, a first load operatively connected to the ground fault detection circuit and a digital controller via a first power bus including a first positive voltage power bus and a first negative voltage power bus, a first relay operatively connected to the first positive voltage power bus, and a second relay operatively connected to the first negative voltage power bus, wherein the ground fault detection circuit is operatively connected to the first relay and the second relay for detecting a ground fault on the first positive voltage power bus or the first negative voltage power bus, a second load operatively connected to the ground fault detection circuit and the digital controller via a second power bus including a second positive voltage power bus and a second negative voltage power bus, a third relay operatively connected to the second positive voltage power bus, and a fourth relay operatively connected to the second negative voltage power bus, wherein the ground fault detection circuit is operatively connected to the third relay and the fourth relay for detecting a ground fault on the second positive voltage power bus or the second negative voltage power bus.

Another example embodiment is a ground fault isolation system for isolating ground faults in electrical subsea conductor lines. The system includes a main power hub, a plurality of subsea electronics module (SEM) controllers operatively connected to the main power hub via electrical subsea conductor lines, and a ground fault isolation circuit. The circuit includes a DC to DC isolation converter for receiving an instrumentation power and isolating the instrumentation power from a main power bus, a ground fault detection circuit operatively connected to the DC to DC converter and configured to detect a ground fault in one or more loads operatively connected to the ground fault detection circuit, a first load operatively connected to the ground fault detection circuit and a digital controller via a first power bus including a first positive voltage power bus and a first negative voltage power bus, a first relay operatively connected to the first positive voltage power bus, and a second relay operatively connected to the first negative voltage power bus, wherein the ground fault detection circuit is operatively connected to the first relay and the second relay for detecting a ground fault on the first positive voltage power bus or the first negative voltage power bus, a second load operatively connected to the ground fault detection circuit and the digital controller via a second power bus including a second positive voltage power bus and a second negative voltage power bus, a third relay operatively connected to the second positive voltage power bus, and a fourth relay operatively connected to the second negative voltage power bus, wherein the ground fault detection circuit is operatively connected to the third relay and the fourth relay for detecting a ground fault on the second positive voltage power bus or the second negative voltage power bus.

Another example embodiment is a method for isolating ground faults in electrical subsea conductor lines using a ground fault isolation system. The method includes operatively connecting a DC to DC isolation converter to a main power bus for receiving an instrumentation power and isolating the instrumentation power from the main power bus, operatively connecting a ground fault detection circuit to the DC to DC converter, wherein the ground fault detection circuit is configured to detect a ground fault in one or more loads operatively connected to the ground fault detection circuit, operatively connecting a first load to the ground fault detection circuit and a digital controller via a first power bus including a first positive voltage power bus and a first negative voltage power bus, operatively connecting a first relay to the first positive voltage power bus, operatively connecting a second relay to the first negative voltage power bus, operatively connecting the ground fault detection circuit to the first relay and the second relay for detecting a ground fault on the first positive voltage power bus or the first negative voltage power bus, operatively connecting a second load to the ground fault detection circuit and the digital controller via a second power bus including a second positive voltage power bus and a second negative voltage power bus, operatively connecting a third relay to the second positive voltage power bus, operatively connecting a fourth relay to the second negative voltage power bus, and operatively connecting the ground fault detection circuit to the third relay and the fourth relay for detecting a ground fault on the second positive voltage power bus or the second negative voltage power bus.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a schematic diagram of a ground fault isolation circuit in accordance with one or more example embodiments of this disclosure.

FIG. 2 is a schematic diagram of a ground fault isolation circuit in accordance with one or more example embodiments of this disclosure.

FIG. 3 is a schematic diagram of a ground fault detection circuit of FIG. 1, in accordance with one or more example embodiments of this disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

A high level of electrical redundancy is required in the offshore hydrocarbon production industry. Embodiments of this disclosure provides an additional level of ground fault detection and isolation, compared to some current systems. Embodiments described in this disclosure can reduce downtime while debugging any electrical issues because specific feedback can be provided regarding where to begin troubleshooting in order to locate the electrical issue. Therefore the additional level of ground fault detection and isolation provided by embodiments of this disclosure can increase the productivity of the subsea systems. Systems and methods described in this disclosure require the addition of minimal electronics to a traditional subsea system and does not require significant additional equipment.

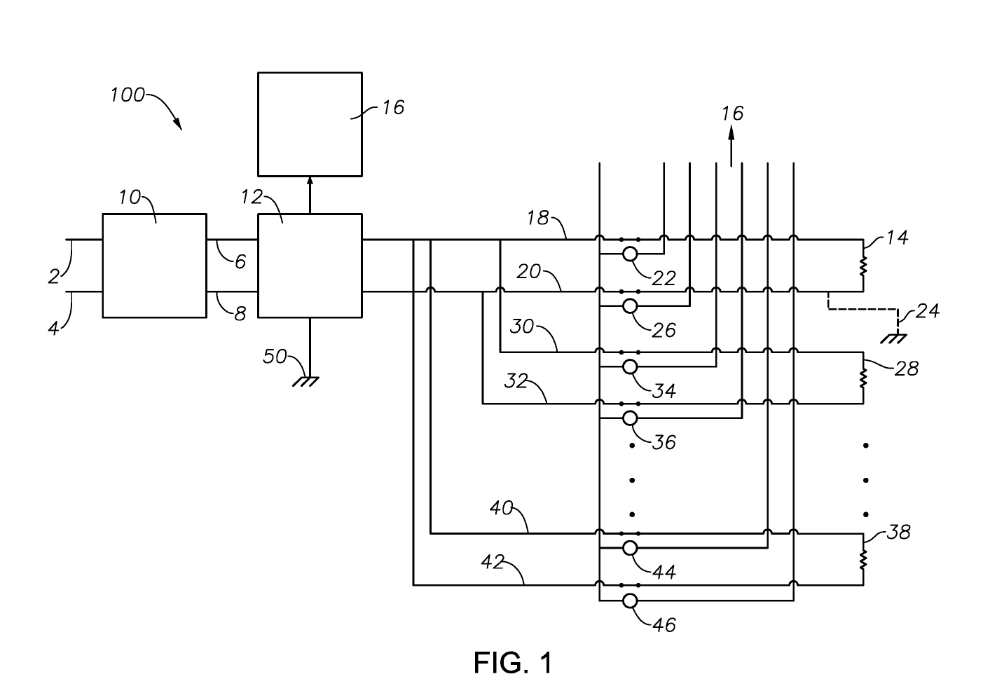

FIG. 1 illustrates a schematic diagram of a ground fault isolation circuit 100 in accordance with one or more example embodiments of this disclosure. Circuit 100 may include a DC to DC isolation converter 10 for receiving an instrumentation power from a main power bus (not shown) via lines 2, 4 and isolating the instrumentation power from the main power bus into isolated VDC lines 6, 8. Although +/−24 VDC is illustrated in these figures, it should be noted that these values are purely exemplary and not limiting in any manner. Circuit 100 may also include a ground fault detection circuit 12 that may be operatively connected to the DC to DC isolation converter 10. The ground fault detection circuit 12 receives the isolated VDC from the DC to DC isolation converter 10 and distributes it to one or more loads 14, 28, 38 that may be connected to it. The ground fault detection circuit 12 may be configured to detect a ground fault 24 in one or more loads 14, 28, 38 operatively connected to the ground fault detection circuit 12. A load as described herein may include a sensor, a transducer, a solenoid, or other loads. A ground fault as described herein may include a current leak of 2 mA-10 mA or greater. In one embodiment, ground fault detection circuit 12 may be grounded to the chassis ground 50.

Circuit 100 may include a first load 14 operatively connected to the ground fault detection circuit 12 and a digital controller 16 via a first power bus including a first positive voltage power bus 18 and a first negative voltage power bus 20. Digital controller 16 may include a subsea electronics module (SEM), for example, or any general purpose digital controller. A first relay 22 may be operatively connected to the first positive voltage power bus 18, and a second relay 26 may be operatively connected to the first negative voltage power bus 20. The ground fault detection circuit 12 may be operatively connected to the first relay 22 and the second relay 26 for detecting a ground fault 24 that may occur on the first positive voltage power bus 18 or the first negative voltage power bus 20. Circuit 100 may also include a second load 28 operatively connected to the ground fault detection circuit 12 and the digital controller 16 via a second power bus including a second positive voltage power bus 30 and a second negative voltage power bus 32. A third relay 34 may be operatively connected to the second positive voltage power bus 30, and a fourth relay 36 may be operatively connected to the second negative voltage power bus 32. The ground fault detection circuit 12 may be operatively connected to the third relay 34 and the fourth relay 36 for detecting a ground fault on the second positive voltage power bus 30 or the second negative voltage power bus 32. Circuit 100 may include additional loads 38, which may be connected to the ground fault detection circuit 12 via power buses 40, 42. Relays 44, 46 may be operatively connected to lines 40, 42, respectively, for detecting a ground fault on power buses 40, 42.

The first power bus and the second power bus may include, for example, a pressure balanced oil filled (PBOF) cable. The first relay 22, second relay 26, third relay 34, fourth relay 36, and relays 44, 46 may include a normally closed relay (NCR) or a solid state relay (SSR). A normally closed relay generally has a closed configuration by default. However, a solid state relay generally has an open configuration by default. The ground fault detection circuit 12 may be configured to isolate the first load 14 when the ground fault is detected on the first load 14, and mitigate further ground fault to the main bus by energizing the first and second relays 34, 36 and disconnecting power from the first load, and powering the second load 28.

In one example embodiment, with the relays de-energized and their contacts are of the normally closed type this allows power to be applied to the load. Once a ground fault is detected all relays on that power bus are energized one at a time. Energizing the relay removes power from the load. The load with the ground fault is then identified when its relays are energized, which will remove power from the load and cause the ground fault to no longer be detected. Accordingly, example embodiments described above offer continuous real-time monitoring while load is still powered. Example embodiments described herein are also able to identify dual polarity faults without the need for additional components. Example embodiments disclosed can distinguish a fault on the positive voltage power bus from a fault on the common or return bus since both the positive voltage power bus and the common or return bus each have a relay, and they can be controlled independently. This essentially allows one to identify which bus is affected by the ground fault.

One example embodiment is a ground fault isolation system for isolating ground faults in electrical subsea conductor lines. The system includes a main power hub, a plurality of digital controllers operatively connected to the main power hub via electrical subsea conductor lines, and a ground fault isolation circuit as described in one of the embodiments described above. The DC power system may include a subsea blow out preventer (BOP) stack that may include a floating chassis system. That is to say neither the positive or negative terminals of the DC power bus are referenced to chassis ground. Each pod may include two or more Subsea Electronics Modules (SEMs) designated as SEM A and SEM B. SEM A and SEM B may be powered by completely separate power supply buses from a power and communications hub, or simply a main power hub. Each SEM may be completely isolated from the other and may have its own parallel set of sensors and solenoids. In the event of a ground fault within a SEM, that ground fault can be mitigated by either isolating the ground fault or powering down the affected SEM power bus. The remaining SEM can remain powered and will not be affected by the loss. The remaining SEM can perform all the associated SEM functions and the affected pod can remain active along with the redundant pod. As a result, a single ground fault will not stop normal BOP operations.

In one example embodiment, the standard voltage for the SEM control power, solenoid valve power, and transducer instrumentation may be 24 VDC, for example. The power system may be divided up into separate power buses for each subsystem. Each main power bus may have its own separate ground fault detection circuit located in the power and communications hub, e.g., main power hub. Ground faults on the main power bus may be detected in the main power hub and reported to the surface controls through a dedicated fiber optic link, for example. The main power hub and SEM electronics may be in separate one atmosphere housings and may be connected by a set of Pressure Balanced Oil Filled Cables, i.e. PBOF cables.

In one example embodiment, digital controller 16 may include two modules, SEM A and SEM B. There may be four or more ground fault detection boards 12 installed in SEM A and four in SEM B. These boards may supply isolated 24 VDC to any device outside the SEM housing. Each board may have a separate ground fault detection circuit and that circuit may send a ground fault alarm to both SEMs. In addition each board may provide current and voltage measurements to both SEMs. In the event of a ground fault, either SEM is capable of powering off the affected device. The isolated power may also have short circuit protection built into the DC to DC isolation converters on the board.

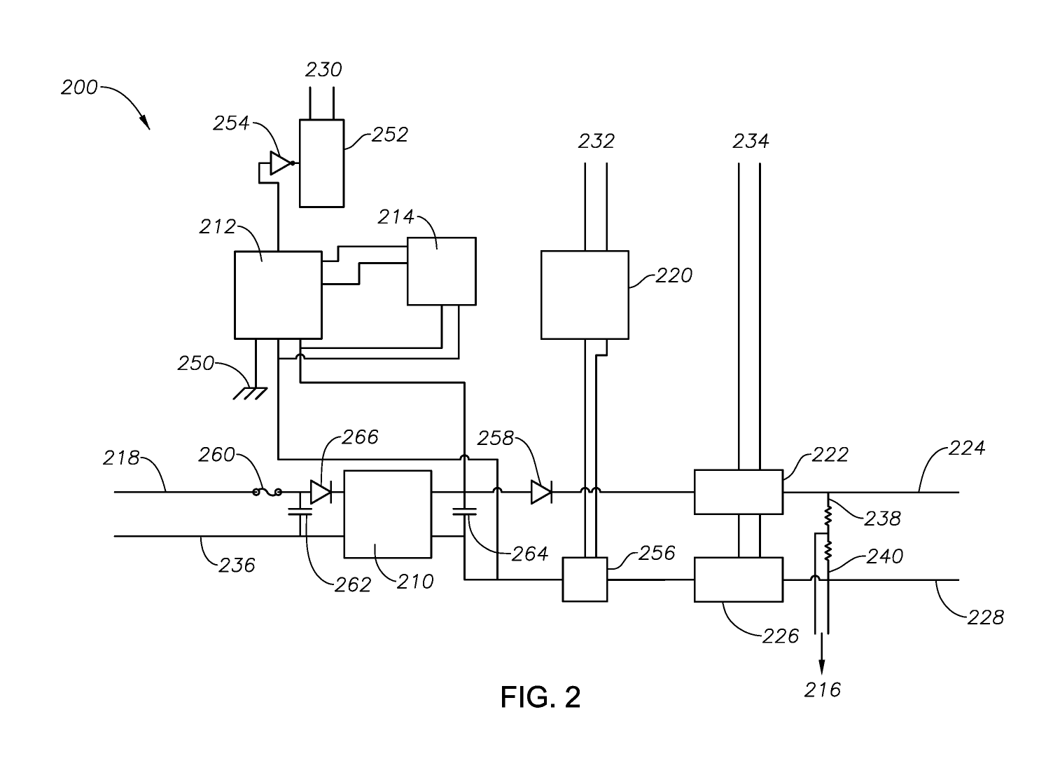

FIG. 2 illustrates a schematic diagram of a ground fault isolation circuit 200 in accordance with one or more example embodiments of this disclosure. Circuit 200 may include a DC to DC isolation converter 210, similar to the DC to DC isolation converter 10 described with respect to FIG. 1. Circuit 200 may also include ground fault detection circuit 212 similar to the ground fault detection 12 in FIG. 1 and relays 222, 226, similar to relays 22, 26 in FIG. 1. Additionally, circuit 200 may include a shunt resistor 256 for measuring current on a negative voltage power bus 228 connected to a digital controller via line 232. Additionally, a circuit breaker 260 may be operatively connected to the DC to DC isolation converter 210 via diodes 266, 258 for isolating the main bus in the event the DC to DC isolation converter fails. Capacitors 262 and 264 may be operatively installed between lines 218 and 236. Under normal operation, DC to DC isolation converter 210 may receive an instrumentation power, for example 24 VDC, from a main power bus via lines 218, 236 and distributes it to one or more loads (not shown) via lines 224, 228. Circuit 200 may also include a 5V DC to DC converter 214, which may be operatively coupled to the ground fault detection circuit 212. Circuit 212 may be grounded to the chassis ground 250.

Ground fault detection circuit 212 may be operatively connected to a relay 252 via a logic gate or a non-inverting buffer amplifier 254 to drive the relay 252, and the output from 252 may be sent to the controller digital input 230. Circuit 200 may also include an instrument amplifier circuit 220 for receiving a signal from the shunt resistor 256 and sending it as a controller analog input current 232. Controller digital output 234 may be sent to relays 222, 226 from the digital controller via line 234, similar to the digital controller 16 illustrated in FIG. 1. Circuit 200 may also include resistors 238, 240, which may include for example 2 k ohm and 4 k ohm resistors, and may be operatively connected between power bus 224, 228 connected to a load (not shown) to monitor voltage across the load. Relays 222, 226, and 252 may be NCR or SSR based on the application.

In one example embodiment, there may be two solid state configuration relays in parallel on the positive bus of both Instrument A power and Instrument B Power. One configuration relay on each bus may be connected to the SEM A controller and the second relay on each bus may be connected to the SEM B controller. This means that the master SEM can determine which instrument bus will power the 24 VDC isolated power to the PBOF cable. After the two configuration relays there may be a remote resettable circuit breaker on both Instrument A and Instrument B positive buses. These circuit breakers may trip at 5 amps and remain tripped until the instrument power is recycled. These circuit breakers are to protect the instrument buses in case of an isolation DC/DC converter failure. After the two DC/DC isolation converters the outputs may be diode coupled together. The current is then measured by reading the voltage across shunt resistors and then converted to a 4 to 20 mA current loop signals for both SEMs. A ground fault detection circuit is also provided and may send alarms to both SEM A and SEM B when a ground fault condition exists. Either SEM can then turn off the output power leaving the board. When the output power is removed the ground fault should clear.

Finally if a short circuit on the output is observed, the DC/DC converter may simply turn off and remain off until the fault is cleared. The DC/DC converter may be fully self-protected. The symptom of a short circuit may be defined as a near zero current and near zero voltage, for example.

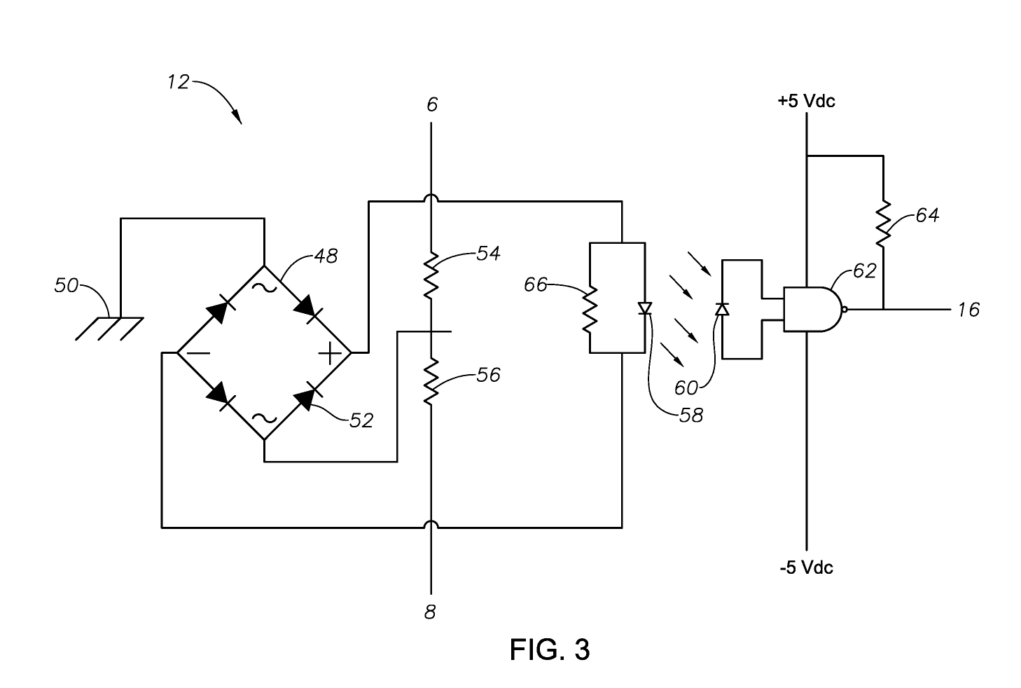

Turning now to FIG. 3, illustrated is a detailed view of an example ground fault detection circuit 12 shown in FIG. 1. A ground fault as described herein may be a current leak to chassis ground of 2 mA or greater by the main power bus from either positive DC bus 6 or negative DC bus 8. A ground fault as described herein is not necessarily a short circuit but a precursor to a short circuit. This may become a short circuit if both positive and negative power buses 6, 8 are ground faulted. In one example embodiment, the ground fault circuit 12 may include a resistor 66 across a photodiode 58, and two resistors 54, 56 of a high value to limit the current yet allow enough current to flow to turn “ON” an LED 60 in the logic isolation circuit. The logic isolation circuit may include a digital logic gate 62 operatively connected to the diode 60, and pull up resistor 64, which may be connected to the +5 VDC from the 5V DC/DC converter 214. The resistors 54, 56 divide the power supply voltage into a suitable value. In turn, via a diode bridge 48 including four diodes 52, this voltage is impressed upon chassis ground 50. All power supplies are isolated and not tied to chassis ground 50. When a power supply bus, either the positive bus or the return bus, comes in contact with chassis ground 50, the impressed voltage on chassis ground forces a limited current to flow turning “ON” the LED which indicates a “Ground Fault” condition.

Accordingly, the ground fault detection circuit 12 may detect a ground fault on the isolated power and send a digital input via line 216 to the subsea electronics module. When a ground fault is detected, the surface operator will receive an alarm based upon this discrete signal and then will have the option to eliminate the ground fault by switching on the subsea ground fault isolation circuit relay using a discrete output from the subsea electronics module, thereby eliminating the ground fault.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first device is operatively connected to a second device, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method has been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A ground fault isolation circuit for isolating ground faults in electrical subsea conductor lines, comprising:
a DC to DC isolation converter for receiving an instrumentation power and isolating the instrumentation power from a main power bus;
a ground fault detection circuit operatively connected to the DC to DC converter and configured to detect a ground fault in one or more loads operatively connected to the ground fault detection circuit;
a first power bus operatively connected to the ground fault detection circuit and a digital controller, wherein the first power bus comprises a first positive voltage power bus and a first negative voltage power bus;
a first relay operatively connected to the first positive voltage power bus, and a second relay operatively connected to the first negative voltage power bus, wherein the ground fault detection circuit is operatively connected to the first relay and the second relay for detecting a ground fault on the first positive voltage power bus or the first negative voltage power bus;
a second power bus operatively connected to the ground fault detection circuit and the digital controller, wherein the second power bus comprises a second positive voltage power bus and a second negative voltage power bus;
a third relay operatively connected to the second positive voltage power bus, and a fourth relay operatively connected to the second negative voltage power bus, wherein the ground fault detection circuit is operatively connected to the third relay and the fourth relay for detecting a ground fault on the second positive voltage power bus or the second negative voltage power bus.

2. The ground fault isolation circuit of claim 1, wherein the ground fault detection circuit is configured to isolate the first power bus by energizing the first and second relays when the ground fault is detected on the first power bus.

3. The ground fault isolation circuit of claim 1, further comprising:
a first shunt resistor for measuring current on the first negative voltage power bus connected to the digital controller.

4. The ground fault isolation circuit of claim 1, further comprising:
a circuit breaker to isolate the main bus if the DC to DC isolation converter fails.

5. The ground fault isolation circuit of claim 1, wherein the ground fault comprises a current leak of 2 mA-10 mA or greater.

6. The ground fault isolation circuit of claim 1, wherein the first power bus or the second power bus comprises a pressure balanced oil filled (PBOF) cable.

7. The ground fault isolation circuit of claim 1, wherein the first relay, second relay, third relay or the fourth relay comprises a normally closed relay (NCR) or a solid state relay (SSR).

8. The ground fault isolation circuit of claim 1, wherein the first power bus is connected to a first load, and the second power bus is connected to a second load.

9. The ground fault isolation circuit of claim 8, wherein the first load or second load comprises a sensor, a solenoid, or a transducer.

10. A ground fault isolation system for isolating ground faults in electrical subsea conductor lines, comprising:
a main power hub;
a plurality of digital controllers operatively connected to the main power hub via electrical subsea conductor lines; and
a ground fault isolation circuit comprising:
a DC to DC isolation converter for receiving an instrumentation power and isolating the instrumentation power from a main power bus;
a ground fault detection circuit operatively connected to the DC to DC converter and configured to detect a ground fault in one or more loads operatively connected to the ground fault detection circuit;
a first load operatively connected to the ground fault detection circuit and a digital controller via a first power bus comprising a first positive voltage power bus and a first negative voltage power bus;
a first relay operatively connected to the first positive voltage power bus, and a second relay operatively connected to the first negative voltage power bus, wherein the ground fault detection circuit is operatively connected to the first relay and the second relay for detecting a ground fault on the first positive voltage power bus or the first negative voltage power bus;
a second load operatively connected to the ground fault detection circuit and the digital controller via a second power bus comprising a second positive voltage power bus and a second negative voltage power bus;
a third relay operatively connected to the second positive voltage power bus, and a fourth relay operatively connected to the second negative voltage power bus, wherein the ground fault detection circuit is operatively connected to the third relay and the fourth relay for detecting a ground fault on the second positive voltage power bus or the second negative voltage power bus.

11. The ground fault isolation system of claim 10, wherein the ground fault detection circuit is configured to isolate the first load when the ground fault is detected on the first load, and energize the third and fourth relays, thereby powering the second load.

12. The ground fault isolation system of claim 10, further comprising:
a first shunt resistor for measuring current on the first negative voltage power bus connected to the digital controller.

13. The ground fault isolation system of claim 10, further comprising:
a circuit breaker to isolate the main bus if the DC to DC isolation converter fails.

14. The ground fault isolation system of claim 10, wherein the ground fault comprises a current leak of 2 mA-10 mA or greater.

15. The ground fault isolation system of claim 10, wherein the first power bus or the second power bus comprises a pressure balanced oil filled (PBOF) cable.

16. A method for isolating ground faults in electrical subsea conductor lines using a ground fault isolation system, the method comprising:
operatively connecting a DC to DC isolation converter to a main power bus for receiving an instrumentation power and isolating the instrumentation power from the main power bus;
operatively connecting a ground fault detection circuit to the DC to DC converter, wherein the ground fault detection circuit is configured to detect a ground fault in one or more loads operatively connected to the ground fault detection circuit;
operatively connecting a first power bus to the ground fault detection circuit and a digital controller, wherein the first power bus comprises a first positive voltage power bus and a first negative voltage power bus;
operatively connecting a first relay to the first positive voltage power bus;
operatively connecting a second relay to the first negative voltage power bus;
operatively connecting the ground fault detection circuit to the first relay and the second relay for detecting a ground fault on the first positive voltage power bus or the first negative voltage power bus;
operatively connecting a second power bus to the ground fault detection circuit and the digital controller, wherein the second power bus comprises a second positive voltage power bus and a second negative voltage power bus;
operatively connecting a third relay to the second positive voltage power bus;
operatively connecting a fourth relay to the second negative voltage power bus; and
operatively connecting the ground fault detection circuit to the third relay and the fourth relay for detecting a ground fault on the second positive voltage power bus or the second negative voltage power bus.

17. The method of claim 16, further comprising:
energizing the first and second relays, thereby isolating the first power bus when the ground fault is detected on the first power bus.

18. The method of claim 16, further comprising:
operatively connecting a first shunt resistor to the digital controller for measuring current on the first negative voltage power bus.

19. The method of claim 16, further comprising:
operatively connecting a circuit breaker to the DC to DC isolation converter to isolate the main bus if the DC to DC isolation converter fails.

20. The method of claim 16, further comprising:
sending an alarm, by the ground fault detection circuit, to the digital controller upon detecting a ground fault.
